(19) United States
(12) Patent Application Publication
(10) Pub. No.: US 2023/0069084 A1
(43) Pub. Date: Mar. 2, 2023

(54) DEVICE FOR HEATING A PRODUCT BY TRANSVERSE FLOW INDUCTION

(71) Applicant: FIVES CELES, Lautenbach (FR)

(72) Inventors: Tony KEZER, Lautenbach (FR); Emmanuel PATARD, Lautenbach (FR)

(21) Appl. No.: 17/801,445

(22) PCT Filed: Feb. 24, 2021
(86) PCT No.: PCT/FR2021/050321

§ 371 Date: Aug. 22, 2022

(30) Foreign Application Priority Data
Feb. 24, 2020 (FR) 2001787

(51) Int. Cl. H05B 6/10; B21B 45/00

(52) U.S. Cl. CPC H05B 6/104; B21B 45/004

(57) ABSTRACT

An inductor intended to heat a flat product by transverse flow induction, with an upper face and a lower face, comprising coils having surfaces which extend over planes, are parallel to each other, and with a thickness in a direction perpendicular to the planes; and a central space between the coils. Wherein at least two coils are disposed on a first side of the central space and at least two coils are disposed on a second side of the central space, wherein on the same side of the central space, the coil closest to the face is spaced apart therefrom by a first distance and the other coils are disposed at a distance from the face that is at least equal to the first distance plus the thickness of the coils between them and the face of the product, and wherein the surfaces of the coils at least partially overlap.

### DESIGNATION OF THE TECHNICAL FIELD CONCERNED

The invention relates to devices for heating products by transverse flow induction, in particular flat products such as slabs, thin slabs and strips.

### Technical Problems Addressed by the Invention

A device for heating a product by transverse flow induction mainly comprises a power source, an inductor and electrical connection elements between these equipment items.

Transverse flow induction heating allows effective heating of products with low magnetic permeability. For example, it allows a carbon steel to be heated beyond its Curie point with a high power density, conventionally up to around 2,500 kW/m2.

This power density may nevertheless be insufficient to obtain the desired temperature increase over a length limited by dimensional or method constraints.

In the steel industry, continuous casting allows the production of flat products continuously and directly from molten metal contained in a ladle. The obtained product can be a slab, with a thickness typically between 35 and 80 mm, a thin slab, with a thickness typically between 5 and 35 mm, or a strip, with a thickness typically less than or equal to 5 mm. After the metal has rapidly cooled in an ingot mold making it possible to solidify the metal, induction heating means allow it to be brought to suitable conditions for rolling, typically at a temperature between 1100° C. and 1250° C., so as to obtain the desired product section and metallurgy after rolling. Depending on the production capacity of the continuous casting, the power required to bring the product to the rolling temperature can be several megawatts. Given the rolling temperature level and the power required, it is known that the heating means is a transverse flow induction installation. However, known high flow transverse flow inductors allow powers limited to about 1.5 MW. To install the necessary useful power, several inductors are placed in series, one after the other. The resulting total length is large, for example 20 m. Steelmakers wish to reduce this length as much as possible. Furthermore, the temperature profile of the product at the end of heating is a determining factor for the quality of the rolling. Current transverse flow heating equipment makes it possible to adjust this temperature profile, in particular to limit overheating of the edges, but only within a limited adjustment range that does not fully meet steelmakers' needs.

The invention provides a solution to these problems with an inductor and a heating installation, the power density of which injected into the product is very high and offers a greater adjustment range for the temperature profile of the product, allowing a better temperature homogeneity to be obtained for the product.

### DISCLOSURE OF THE INVENTION

According to a first aspect of the invention, there is provided an inductor intended to heat a flat product by transverse flow induction, said product having an upper face and a lower face, said inductor comprising coils having surfaces which are substantially parallel to each other, and a thickness in a direction perpendicular to these planes, the inductor also comprising a central space between the coils that is intended to receive the product, wherein at least two coils are disposed on a first side of the central space and at least two coils are disposed on a second side of the central space opposite the first, and on the same side of the central space, the coil closest to the face of the product is spaced apart therefrom by a first distance and the other coils are disposed at a distance from the face of the product that is at least equal to the first distance plus the thickness of the coils arranged between them and the face of the product, and the surfaces of the coils at least partially overlap.

The presence of at least two coils that at least partially overlap on each side of the product makes it possible to vary the magnetic field lines generated and thus to control the temperature rise per unit of area of the product.

The invention is particularly useful for inductors equipped with high flow cons, that is to say, made with particular conductors, for example comprising a plurality of strands arranged around a tube forming a core through which a coolant passes, as described by FR2989817 by the applicant.

According to the invention, the coils placed on the same side of the product are as dose as possible to each other, in a direction perpendicular to the surfaces on which the coils extend, and preferably in contact with each other, in order to limit parasitic heating and the drop in efficiency of the inductor that would result from a space between the coils.

According to one embodiment of the invention, the relative position of the coils, with respect to each other, is adjustable so that the central axes of the coils perpendicular to the surfaces on which the coils extend are all coincident, so that these central axes of the coils are all distinct or so that some are coincident and others are distinct in a direction parallel to the surfaces.

According to one possibility, the relative position of the coils with respect to each other is adjustable based on the width of the product and/or based on the length of the product.

According to the invention, the coils located on the same side of the product to be heated can be offset from one another. This offset can be only in a direction transverse to the product, only in a longitudinal direction with respect to the product, or both in a longitudinal direction and a direction transverse to the product.

Likewise, the coils placed on either side of the product can face each other or they can be offset only in a direction transverse to the product, only in a longitudinal direction with respect to the product, or both in a longitudinal direction and a direction transverse to the product. The offset may only concern part of the coils. For example, with an inductor according to the invention with two coils on each side of the product, the two coils closest to the product can face each other while the two outer coils can be offset, or vice versa. The facing position of the coils is the position with the best efficiency. An offset of the coils can be carried out in particular to influence the temperature profile of the product, but it will result in lowering the efficiency of the installation.

According to the invention, the relative position of the coils of an inductor, on either side of the product, is also adjustable so as to modify the distance between the substantially parallel surfaces on which the coils extend, that is to say, to modify the air gap.

Thus, according to the invention, it is possible to modify the distance between the coils and the product, that is to say, to increase or decrease the air gap. Thus, it is possible to increase the air gap if it is desired to lower the power density transmitted to the product, for example to reduce a temperature heterogeneity of the product that would result from an excessively high power density. Advantageously, the movement of the coils is carried out so that the product is centered between the coils, that is to say that there is substantially the same distance between the product and the first coil located on each side of the product.

On the same face of the product, the second coil starting from the face of the product is positioned at a distance from the product at least equal to the distance at which the first coil is placed, increased by the thickness of the latter. According to the invention, it is possible to modify the distance between the coils located on the same side of the product to be heated. It is thus possible to move the second coil away from the first so as to modify the power density transmitted to the product. In a configuration with more than two coils on one face of the product, the position of the complementary coils is also adjustable relative to the other coils so as to move them away from or bring them closer to the product.

According to a second aspect of the invention, there is proposed a transverse flow induction heating installation for a product comprising at least one inductor according to one of the preceding variant embodiments and at least one power source electrically connected to said inductor.

Depending on the characteristics of the inductor and of the power source, the electrical connection between these two equipment items may comprise a current step-up or step-down transformer and/or capacitors.

The installation may comprise a means capable of modifying the distance of a coil from the face of the product that is closest to it.

According to one possibility, the installation may comprise means capable of modifying the relative position of a first coil with respect to a second coil based on the width of the product and/or based on the length of the product.

According to an alternative embodiment of the invention, the coils of an inductor disposed on one side of the central space of said inductor are supplied by a first power source of the at least one power source and the coils disposed on the other side of the central space are supplied by a second power source of the at least one power source.

According to another embodiment of the invention, the two coils closest to the central space are supplied by a first power source of the at least one power source and the two coils furthest from the central space are supplied by a second power source of the at least one power source. In the case where the inductor comprises more than four coils, the coils located between the two coils closest to the central space and the two coils furthest from the central space can be supplied by one or the other of the two power sources.

The power sources can be disposed on the same side of the product, in a direction transverse thereto, or on each side of the product in this transverse direction.

Thus, according to an embodiment of the invention with two coils on each side of the central space, the two coils closest to the central space, constituting a first pair of cons, can be supplied by a first power source disposed on one side of the product and the two cons furthest from the central space, constituting a second pair of coils, can be supplied by a second power source disposed on the other side of the product.

According to an alternative embodiment of the invention, the two power sources have different power, the maximum power flow that can be transmitted to the product by the two pairs of coils being different.

According to an alternative embodiment of the invention, the transverse flow induction heating installation comprises at least two successive inductors in the longitudinal direction of the product. Thus, the first inductor is for example intended to ensure a first rise in temperature of the product and the second inductor is intended to ensure a complementary rise in temperature of the product. The two inductors can have the same effect on the temperature profile of the product at the outlet of the inductor or can have different effects, for example opposite effects, depending on the relative position of the coils of the inductors. Thus, for example, a first inductor can have a working position of the coils leading to a strong rise in temperature of one of the two edges of the product, in a direction transverse thereto, while the second inductor has an opposite working position of the coils leading to a sharp rise in temperature of the other edge of the product. It is thus possible to adjust the temperature profile of the product after each inductor so as to obtain the desired temperature profile at the outlet of the last inductor. For example, with a solution comprising two successive inductors and a product entering the first inductor with edges colder than its center, the first inductor can raise the temperature level of a first edge of the product and the second inductor can raise the temperature of the second edge of the product so that at the outlet of the second inductor, the product has reached the desired temperature rise while having a homogeneous temperature, or the desired temperature profile.

According to a third aspect of the invention, there is proposed a method for transverse flow induction heating of a product by means of an installation according to one of the embodiments described above, characterized in that the relative position of the coils of an inductor, with respect to each other and with respect to the product, is adjusted according to the temperature profile of the product targeted at the output of the inductor.

The position of the coils can be adjusted manually by an operator, the latter positioning the coils, then clamping them in the working position. The adjustment can be carried out using mechanical means, for example translation systems of the rack or slide type. It can also be produced by electric, pneumatic or hydraulic means, for example by means of jacks. The adjustment can be automatic, by motorizing the movements.

The adjustment of the position of the coils can be carried out by an action of an operator or automatically according to the characteristics of the product, in particular its width, and/or the desired temperature profile of the product at the outlet of the inductor.

### BRIEF DESCRIPTION OF THE FIGURES

Other features and advantages of the invention will become apparent from the detailed description that follows, for the understanding of which reference is made to the appended drawings, in which:

FIG. 1 is a schematic longitudinal sectional view of an inductor, according to one embodiment of the invention, in a first working position.

FIG. 2 is a schematic cross-sectional view of the inductor shown in FIG. 1, in the same working position as in FIG. 1.

FIG. 3 is a schematic top view of the inductor shown in the previous figures, in the same working position as in FIGS. 1 and 2.

FIG. 4 is a schematic top view of the inductor shown in the previous figures, in a second working position.

FIG. 5 is a schematic cross-sectional view of the inductor shown in the previous figures, in the same working position as in FIG. 4.

FIG. 6 is a schematic top view of the inductor shown in the previous figures, in a third working position,

FIG. 7 is a schematic longitudinal view of the inductor shown in the previous figures, in the same working position as in FIG. 6.

FIG. 8 is a schematic longitudinal view of the inductor shown in the previous figures, in a fourth working position.

FIG. 9 is a schematic longitudinal sectional view of an inductor according to the invention according to two embodiments of a cylinder head, the upper part of the figure illustrating a first example and the lower part of the figure illustrating a second example.

FIG. 10 is a typical electrical circuit diagram illustrating a first example of connection of the coils of an inductor according to the invention.

FIG. 11 is a typical electrical circuit diagram illustrating a second example of connection of the coils of an inductor according to the invention.

FIG. 12 is a typical electrical circuit diagram illustrating a third example of connection of the coils of an inductor according to the invention.

FIG. 13 is a typical electrical circuit diagram illustrating a fourth example of connection of the coils of an inductor according to the invention.

FIG. 14 is a diagram illustrating an example implementation of the method according to the invention with the evolution of the transverse temperature profile of a product at the outlet of four successive inductors according to the invention.

Since the embodiments described hereinafter are not limiting in nature, it is possible in particular to consider variants of the invention that comprise only a selection of the features that are described, provided that this selection of features is sufficient to confer a technical advantage or to differentiate the invention from the prior art. This selection comprises at least one preferably functional feature without structural details, or with only a portion of the structural details if this portion alone is sufficient to confer a technical advantage or to differentiate the invention from the prior art.

In the remainder of the description, elements having an identical structure or similar functions will be designated by the same references.

### DETAILED DESCRIPTION OF THE INVENTION

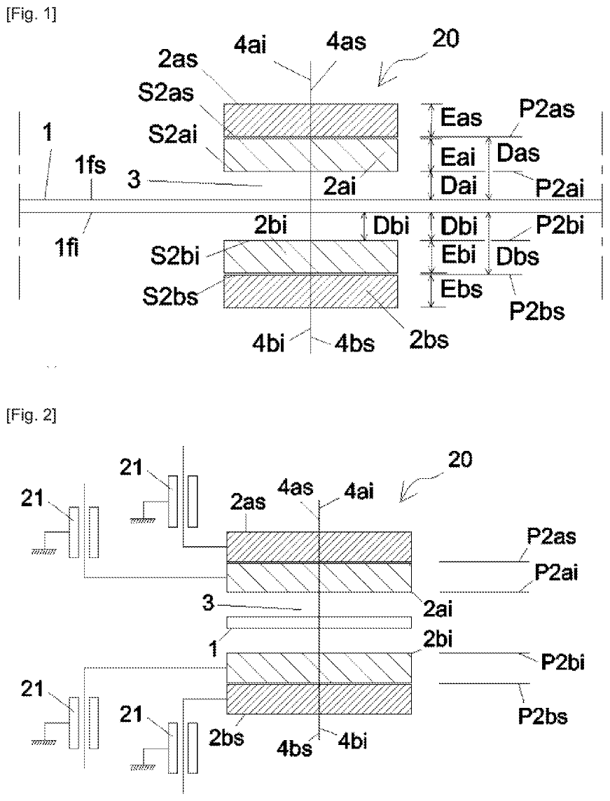

FIGS. 1 to 8 schematically illustrate the same embodiment of an inductor 20 according to the invention in working positions that may be different. The inductor allows the heating of a flat product 1. This product defines a longitudinal direction in the length direction of the product and a transverse direction in the width direction of the product.

A transverse flow inductor typically comprises coils that generate an electromagnetic field at the origin of the heating of the product and cylinder heads intended to channel this magnetic field to improve the efficiency of the inductor. On each side of the product to be heated, the coil and the cylinder heads are fixed on a plate. The inductor typically comprises thermal protection constituting a barrier to radiation from the product. This thermal protection can also be gas-tight when it is necessary to place the product in an atmosphere other than air, for example in an atmosphere that does not oxidize the product. As a variant, the gas tightness can be achieved separately from the thermal protection. To simplify the representation of the invention, only the coils are shown in the figures.

FIGS. 1 to 3 schematically illustrate the inductor 20 in a first example of a working position. FIG. 1 is a longitudinal sectional view of the inductor, FIG. 2 is a cross-sectional view of the inductor and FIG. 3 is a top view of the inductor.

The inductor 20 comprises two pairs of coils 2as, 2ai, 2bs, 2bi arranged on either side of a central space 3 in which the product 1 to be heated is located. It can be seen in these FIGS. 1 to 3 that, in this example of a working position, the four coils are perfectly superimposed, their central axes 4as, 4ai, 4bs, 4bi being coincident in the longitudinal and transverse directions. This configuration is suitable for example in the case where the dimensions of the coils make it possible to cover the width of the product to be heated when they are superimposed.

From the upper face 1fs of the product 1 to be heated, the first coil 2ai is at a distance Dai, that is to say, the plane P2ai on which the surface S2ai of the coil 2ai Iles is distant from the upper face 1fs of the product by a length Dai. This distance Dai strongly influences the power density transmitted to the product by the coil. In order to be able to adjust the power transmitted to the strip, this distance can be adjusted by means 21 shown in FIG. 2.

This means 21 for example comprises a worm whose longitudinal axis is perpendicular to the face 1fs of the product and a nut fixed on the coil with which the worm cooperates. Thus, the position of the coil is adjusted by rotating the worm. The means 21 can also be a rack, a linear motor, a jack or any other known means.

The second coil 2as is placed at a distance Das from the upper face 1fs of the product, that is to say, the plane P2as on which the surface S2as of the coil 2as lies is distant from the upper face 1fs of the product by a length Das. This distance Das is at least equal to the distance Dai at which the first coil is positioned, increased by the thickness of the latter. This distance Das also strongly influences the power density transmitted to the product by the coil. In order to be able to adjust the power transmitted to the strip, the distance Das can also be adjusted by a second means 21 shown in FIG. 2.

From the face 1fi of the product 1 to be heated, the first coil 2bi is at a distance Dbi, i.e. the plane P2bi on which the surface S2bi of the coil 2b lies is distant from the lower face 1fi of the product by a length Dbi. This distance Dbi strongly influences the power density transmitted to the product by the coil. In order to be able to adjust the power transmitted to the strip, this distance can be adjusted by a means 21 shown in FIG. 2.

The second coil 2bs is placed at a distance Dbs from the lower face 1fi of the product, that is to say, the plane P2bs on which the surface S2bs of the coil 2bs lies is distant from the lower face 1fi of the product by a length Dbs. This distance Dbs is at least equal to the distance Dbi at which the first coil is positioned, increased by the thickness of the latter. This distance Dbs also strongly influences the power density transmitted to the product by the coil. In order to be able to adjust the power transmitted to the strip, the distance abs can also be adjusted by a second means 21 shown in FIG. 2.

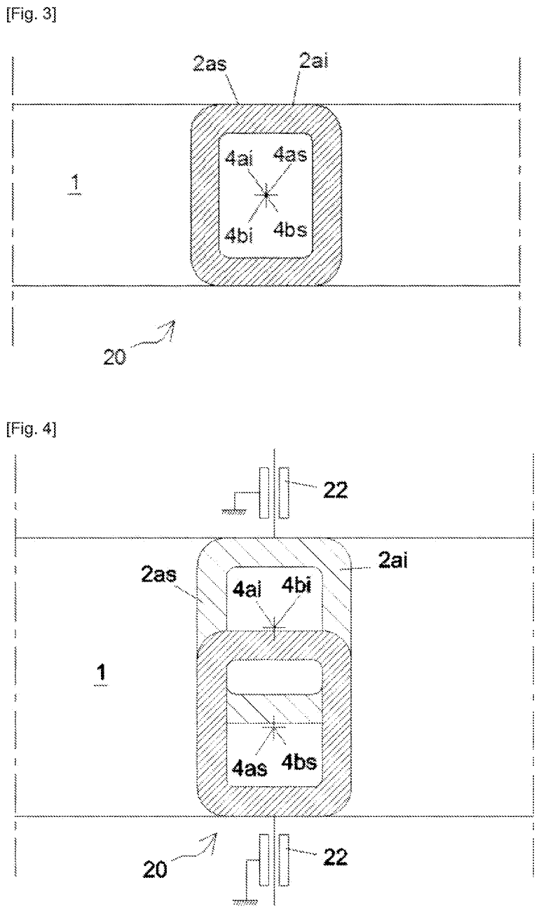

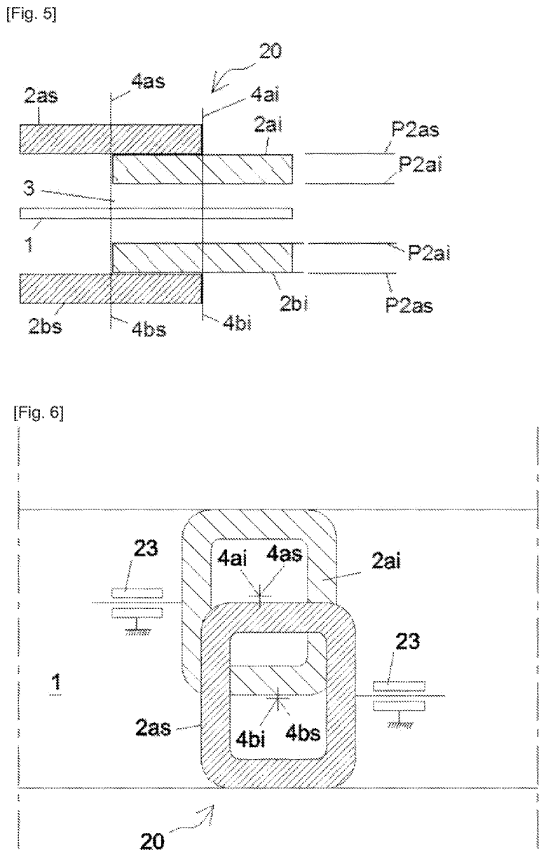

FIGS. 4 and 5 illustrate the inductor 20 in a second working position that is suitable for a greater product width than in the first example of a working position. FIG. 4 is a top view of the inductor and FIG. 5 is a cross-sectional view of the inductor. The longitudinal sectional view of the inductor would be identical to FIG. 1, the position of the coils in the longitudinal direction being the same for these two working position examples. In this second working position, the coils are offset transversely to cover the entire width of the product.

The transverse position of a coil is adjustable by a means 22 shown in FIG. 4. This means 22 for example comprises a worm whose longitudinal axis is parallel to the face 1fs of the product and a nut fixed on the coil with which the worm cooperates. Thus, the position of the coil is adjusted by rotating the worm. The means 22 can also be a rack, a linear motor, a jack or any other known means. In the embodiment of FIG. 4, the two coils arranged on the same face of the product are equipped with a means 22 for adjusting their transverse position. According to another embodiment of the invention, only one coil is equipped with a means 22 for adjusting its transverse position.

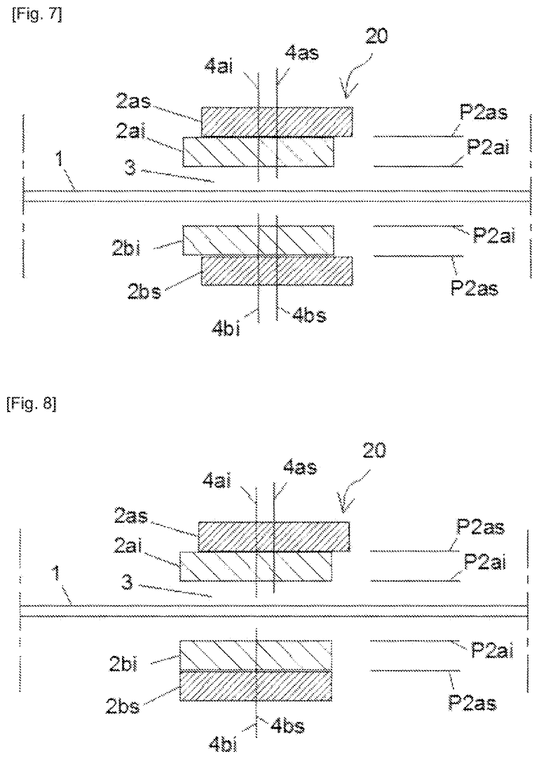

FIGS. 6 and 7 illustrate the inductor 20 in a third working position. FIG. 6 is a top view of the inductor and FIG. 7 is a longitudinal sectional view of the inductor. The cross-sectional view of the inductor would be identical to FIG. 5, the position of the coils in the transverse direction being the same for the second and the third working position examples.

The longitudinal position of a coil is adjustable by means 23 shown in FIG. 6. This means 23 may be similar to that for adjusting the transverse position of a coil or it may be different. In the embodiment of FIG. 6, the two coils arranged on the same face of the product are equipped with a means 23 for adjusting their longitudinal position. According to another embodiment of the invention, only one coil is equipped with a means 23 for adjusting its longitudinal position.

FIG. 8 shows the inductor 20, in longitudinal sectional view, in a fourth working position. This example illustrates a working position in which there is asymmetry between the coils with regard to the product to be heated. Thus, the coil 2as is not opposite the coil 2bs. Any other variant of asymmetry is possible according to the invention.

A coil is advantageously produced by an assembly of conductors. Each conductor comprises a plurality of strands of electrically conductive material, for example copper, arranged around a tube of electrically insulating material forming a core through which a coolant flows. The strands are impregnated with an electrical insulating paste having a good coefficient of thermal conductivity to ensure good heat transfer between the strands and the tube. A coil is for example produced by an assembly of juxtaposed conductors on the same plane of the coil. At each end, the conductors are electrically connected to one another in a connection element to the power source. Likewise, at each end, the tubes of insulating material open into a cavity forming a coolant supply or discharge manifold, depending on the end.

Advantageously, a coil comprises two superimposed and juxtaposed assemblies as described above, that is to say, two layers of conductors on two parallel planes. In an alternative embodiment, the elements for connection to the power source and/or the points of connection to the coolant are common to the two layers of conductors.

To simplify the figures illustrating the coils, the electrical and hydraulic connections thereof have not been shown.

According to an alternative embodiment of the invention, the inductor comprises at least one cylinder head on each side of the product. A cylinder head is made by a stack of silicon steel sheets separated by an electrical insulator. This stacking allows the cylinder head to channel the electromagnetic field generated by the coils while preventing the flow of electric current in the cylinder head. FIG. 9 illustrates two embodiments of a cylinder head 5 in longitudinal sectional view at mid-width of a product 1, knowing that on a real inductor, the cylinder heads are identical on both sides of the inductor. In the upper part of the figure, the cylinder head has a central extension assuming a position inside the coils. This is absent in the variant embodiment shown in the lower part of the figure. The efficiency of the cylinder head is better if it comprises a central extension, but this limits the possible transverse travel for the coils. Conversely, an inductor with cylinder heads with no central extension will have a lower efficiency, but it will offer a greater adjustment range for the relative position of the coils.

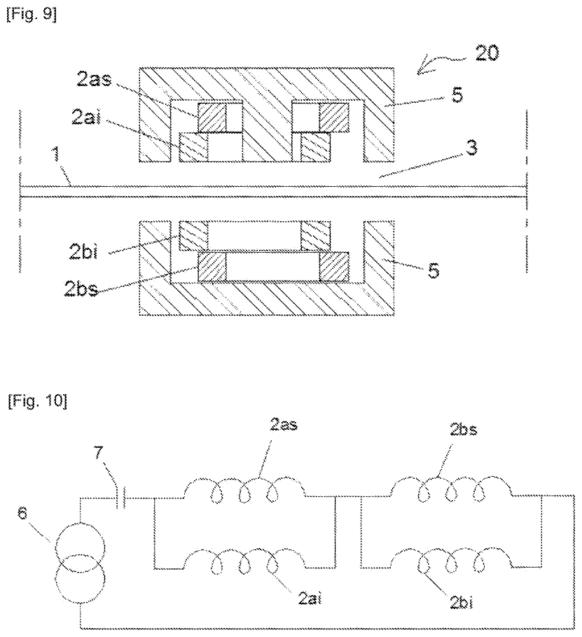

FIGS. 10 to 13 are simplified electrical diagrams that illustrate different variants for connecting an inductor with two pairs of coils according to the invention, by way of non-limiting examples,

FIG. 10 illustrates a series/parallel assembly in which a power source 6 supplies the four coils of the inductor, two coils located on the same side of the product 2as, 2ai, being connected in parallel, the other two coils 2bs, 2bi, located on the other side of the product, also being connected in parallel, the two pairs of coils being connected in series. The circuit comprises a capacitor 7 arranged in series.

FIG. 11 illustrates a series assembly in which the inductor is supplied by two power sources 6. One power source 6 supplies the pair of coils 2as, 2bs furthest from the product, the latter being connected in series. The second power source 6 supplies the pair of coils 2ai, 2bi closest to the product, the latter also being connected in series. Each circuit comprises a capacitor 7 arranged in series.

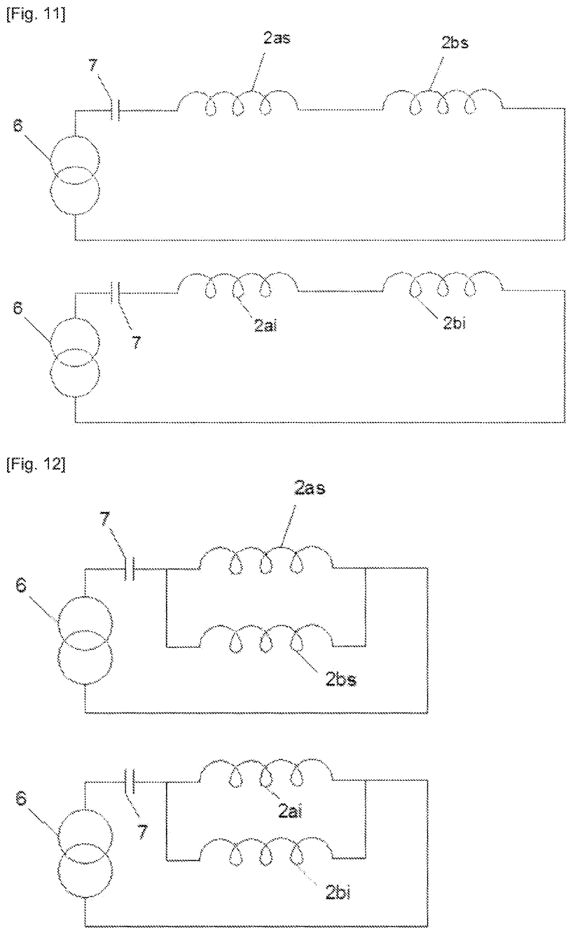

FIG. 12 also illustrates a configuration with two power sources 6, but the coils of which are connected in parallel, Thus, one power source 6 supplies the pair of coils 2as, 2bs furthest from the product, these being connected in parallel, and the second power source 6 supplies the pair of coils 2ai, 2bi closest to the product, these also being connected in parallel. Again, each circuit comprises a capacitor 7 arranged in series.

In the variants shown in FIGS. 11 and 12, the two power sources 6 can be placed on the same lateral side of the product, or one source can be placed on each side of the product.

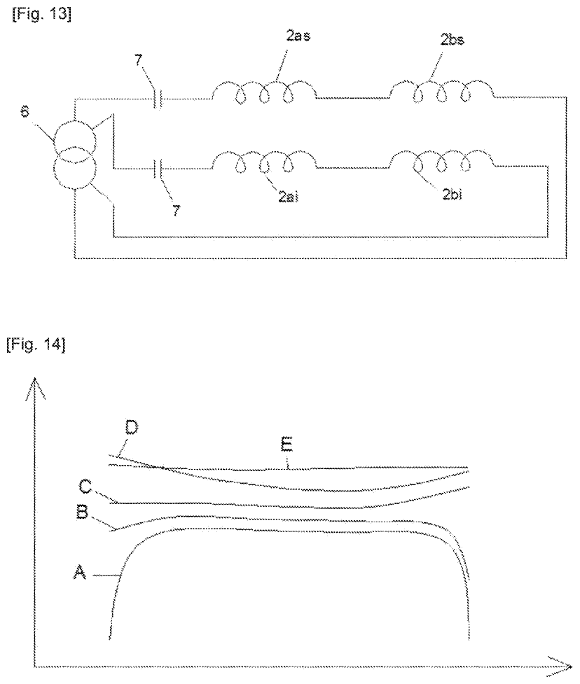

FIG. 13 illustrates an arrangement close to that shown in FIG. 12 in which the inductor is supplied by a dual-output power source 6. One output of the power source 6 supplies the pair of coils 2as, 2bs furthest from the product, the latter being connected in series. The second output of the power source 6 supplies the pair of coils 2ai, 2bi closest to the product, the latter also being connected in series. Each circuit comprises a capacitor 7 arranged in series.

According to an example application of the invention to the case of producing thin steel slabs by continuous casting, four successive installations make it possible to raise the temperature of the product from 900° C. to 1000° C. Each installation comprises a power source connected to an inductor having two coils arranged on each side of the product. The coils are electrically connected according to the schematic diagram in FIG. 10. They are supplied with a current of up to 4000 A at a voltage of 2500 V and a frequency of 1000 Hz. The relative position of the coils of the four installations is adjusted so as to obtain, at the output, a product at 1000° C. having the desired transverse temperature profile.

FIG. 14 shows a diagram of the change in the transverse temperature of a product which illustrates an embodiment of the method according to the invention for this example of application of reheating a thin slab. On the y-axis of this diagram is the temperature of the product and, on the x-axis, the width of the product. Curve A represents the transverse temperature profile of the product at the inlet of the first inductor, with the edges of the product appreciably colder than the center. Curve B represents the temperature profile of the product at the outlet of the first inductor. The relative position of the coils of the first inductor is such as to promote strong heating of the edge of the product located to the left of the diagram. Curve B represents the temperature profile of the product at the outlet of the second inductor. The relative position of the coils of the second inductor is such as to promote greater heating of the edge of the product located to the right of the diagram. Curve B represents the temperature profile of the product at the outlet of the third inductor. The relative position of the coils of the third inductor is such as to promote slightly greater heating of the edge located to the left of the diagram. Curve B represents the temperature profile of the product at the outlet of the fourth and final inductor. The relative position of the coils of the final inductor is such as to promote slightly greater heating of the edge located to the right of the diagram so as to obtain a homogeneous temperature profile of the product.

1. Inductor intended to heat a flat product by transverse flow induction, said product having an upper face and a lower face, said inductor comprising coils having surfaces which extend over planes which are substantially parallel to each other, and a thickness in a direction perpendicular to these planes, the inductor also comprising a central space between the coils that is intended to receive the product, wherein at least two coils are disposed on a first side of the central space and at least two coils are disposed on a second side of the central space opposite the first, characterized in that on the same side of the central space, the coil closest to the face of the product is spaced apart therefrom by a first distance and the other coils are disposed at a distance from the face of the product that is at least equal to the first distance plus the thickness of the coils arranged between them and the face of the product, and in that the surfaces of the coils at least partially overlap.

2. Inductor according to claim 1, the coils having a central axis perpendicular to the surfaces, wherein the relative position of the coils, with respect to each other, is adjustable so that the central axes of the coils are all coincident, so that the central axes of the coils are all distinct or so that some are coincident and others are distinct in a direction parallel to said surfaces.

3. Inductor according to claim 2, wherein the relative position of the coils with respect to each other is adjustable based on the width of the product and/or based on the length of the product.

4. Inductor according to claim 1, wherein the relative position of the coils with respect to each other is adjustable so as to modify the distance between two substantially parallel surfaces on which the coils extend.

5. Inductor according to claim 4, wherein the relative position of the coils is adjustable so as to modify the distance of the coils from the face of the product that is closest to them.

6. Installation for transverse flow induction heating of a product comprising at least one inductor according to claim 1 and at least one power source electrically connected to said inductor.

7. Installation for transverse flow induction heating of a product according to claim 6, wherein it comprises a means capable of modifying the distance of a coil from the face of the product that is closest to it.

8. Installation for transverse flow induction heating of a product according to claim 6, wherein it comprises means capable of modifying the relative position of a first coil with respect to a second coil based on the width of the product and/or based on the length of the product.

9. Installation for transverse flow induction heating of a product according to claim 6, wherein the coils of an inductor disposed on one side of the central space of said inductor are supplied by a first power source of the at least one power source and the coils disposed on the other side of the central space are supplied by a second power source of the at least one power source.

10. Installation for transverse flow induction heating of a product according to claim 6, the coils closest to the central space being supplied by a first power source of the at least one power source and the coils furthest from the product are supplied by a second power source of the at least one power source.

11. Installation for transverse flow induction heating of a product according to claim 6, wherein it comprises at least two successive inductors in the longitudinal direction of the product.

12. Method for transverse flow induction heating of a product by means of an installation according to claim 6, wherein the relative position of the coils, with respect to each other and with respect to the product, of an inductor is adjusted according to the temperature profile of the product targeted at the output of the inductor.
